(19) United States
(12) Patent Application Publication
(10) Pub. No.: US 2008/0027856 A1
(43) Pub. Date: Jan. 31, 2008

(54) COMPUTER SYSTEM AND METHOD FOR CALCULATING AND DISPLAYING VEHICLE LOAN PARAMETERS

(75) Inventors: Tim Owens, Charlotte, NC (US); Erick Mick, Charlotte, NC (US); Jennifer Blamy, Charlotte, NC (US)

Correspondence Address: KING & SPALDING LLP, 1180 PEACHTREE STREET, ATLANTA, GA, 30309-3521, US

(73) Assignee: LendingTree, LLC, Charlotte, NC (US)

(21) Appl. No.: 11/459,941

(22) Filed: Jul. 26, 2006

(51) Int. Cl. G06Q 40/00

(52) U.S. Cl. 705/38

(57) ABSTRACT

A computer implemented method and system for displaying and calculating a vehicle loan can include input fields for adjusting parameters associated with the vehicle loan. The system can provide selectable gauges that can be used to adjust parameters of the vehicle loan. The gauges can comprise analog displays that include an indicator, such as a needle or graphical blocks. The indicator can be selected and repositioned. The gauges can have a design, shape, and feel that resemble gauges of a vehicle, like an automobile. The gauges can display relative values that simulate relative values found in a vehicle, like an automobile. The system can comprise a three tier computer architecture with a computer server, a back-end system, and a client computer. In one exemplary embodiment, the software can run on the client computer and then access certain graphical files for the gauges that can be stored on the computer server.

### TECHNICAL FIELD

The invention relates to a computer for calculating and displaying loan parameters. More particularly, the invention relates a computer for calculating and displaying vehicle loan parameters in which the parameters can be displayed and modified using displayable vehicle-like gauges.

### BACKGROUND OF THE INVENTION

Conventional computers that provide displays for vehicle loan calculations generally are very plain and do not encourage a user to interact with them. Usually, computer displays for vehicle loan calculations allow a user to modify or select loan parameters through conventional drop down menus and/or input boxes for receiving typed-in numbers from a keyboard. Example vehicle loan parameters include, but are not limited to, term or length of the loan (usually in months), loan amount (usually in dollars), monthly payment amount (usually in dollars and cents), and interest rate (usually an annual percentage rate).

An average user of a vehicle loan calculator may not be interested in simple math calculations. That is, a conventional computer vehicle loan calculator may not keep the attention of an average user because of the basic, dull display of numbers of the vehicle loan calculator. A user may find the basic display of only numbers to lack excitement or that the display of numbers may be less engaging to the user.

Without engaging the interest or attention of a user of the computer vehicle loan calculator, the user will likely fail to appreciate the relationships between the different loan parameters such as between the interest rate, loan amount, and monthly payment amount. Another problem of conventional computer vehicle loan calculators is that computer programming instructions for such calculators can often be complex. In some instances, conventional computer vehicle loan calculators can consume significant server or back-end computer processing power in which a single server must execute numerous instances of the same complex vehicle loan calculator program for each client computer that is engaged with the single server. This parallel execution of complex vehicle loan calculator programs can drain the resources of a server to process other computer programs.

Accordingly, there is a need in the art for a computer implemented method and system for displaying and calculating vehicle loans without consuming significant computer server resources. There is also need in the art for a user interface to a computer vehicle loan calculator that will engage the interest of a user and that may readily display relationships between vehicle loan parameters in a graphical manner as well as providing exact parameters that can be useful to the computer user.

### SUMMARY OF THE INVENTION

A computer implemented method and system for displaying and calculating a vehicle loan can include various input fields for adjusting parameters associated with the vehicle loan as well as one or more selectable gauges that can also be used to adjust parameters of the vehicle loan. The gauges or the input fields can be manipulated so that upon changing a first parameter associated with the vehicle loan, the other remaining parameters associated with the vehicle loan as well as the selected first parameter can be automatically adjusted and redisplayed with their new values that correspond to the change of the first parameter.

According to one exemplary aspect of the invention, a region of a first gauge corresponding to a first vehicle loan parameter can be selected to change a relative displayed value of the first gauge. After the region of the first gauge is selected, a value associated with the region can be looked up in a table and that value to can be used to calculate the remaining vehicle loan parameters. Once the remaining vehicle loan parameters are calculated, gauge regions associated with the calculated loan parameters can be looked up in the table. The selected vehicle loan parameter, the calculated vehicle loan parameters, the gauge regions associated with the calculated vehicle loan parameters, and the selected gauge region can then be displayed.

According to another exemplary aspect of the invention, a user can select and change a numerical input region for a vehicle loan parameter. The remaining vehicle loan parameters can be calculated and corresponding gauge regions can be looked up in a table similar to the method discussed above when a gauge region has been selected.

According to another exemplary aspect of the invention, the gauges can comprise analog displays that include an indicator, such as a needle, that can be selected and repositioned. The gauges can also have a design and feel that resemble gauges of a vehicle, like an automobile. The gauges can also display relative values that simulate relative values found in a vehicle, like an automobile. For example, a gauge displaying a loan amount can be scaled in such a manner that it resembles a gauge for tracking automobile speed, such as a speedometer. As another example, a gauge displaying monthly payment can be scaled in such a manner that it resembles a gauge for tracking revolutions per minute (RPM) of an engine of automobile, such as a tachometer. According to another exemplary aspect, the gauges can comprise digital graphics with indicators comprising blocks that can be selected.

According to one exemplary aspect of the invention, most of the processing for the vehicle loan calculator can be performed by the client side in a three tier computer architecture that may comprise a computer server, a back-end system, and a client computer. The vehicle loan calculator can run mostly on the client computer and then access certain graphical files for the gauges that can be stored on the server. However, the invention is not limited to this aspect, and the technology could run entirely on a server or be shared between a client computer and a server as preferred for a particular application.

### BRIEF DESCRIPTION OF THE DRAWINGS

FIG. 1 is a functional block diagram of an exemplary computer architecture according to one exemplary embodiment of the invention.

FIG. 2 is a functional block diagram illustrating some core components of a vehicle loan computer module according to one exemplary embodiment of the invention.

FIG. 3 is an exemplary vehicle loan gauge display with values according to one exemplary embodiment of the invention.

FIG. 4A is an exemplary vehicle loan gauge display in which the loan term can be selected from a drop down menu according to one exemplary embodiment of the invention.

FIG. 4B is an exemplary gauge position/variable range mapping table according to one exemplary embodiment of the invention.

FIG. 4C is an exemplary vehicle loan gauge that corresponds to one range of values listed in the gauge position/variable range mapping table according to one exemplary embodiment of the invention.

FIG. 4D is another exemplary vehicle loan gauge that corresponds to one range of values listed in the gauge position/variable range mapping table according to one exemplary embodiment of the invention.

FIG. 5 is an exemplary vehicle loan gauge display in which loan parameters are changed in response to selection of a loan amount gauge according to one exemplary embodiment of the invention.

FIG. 6 is an exemplary vehicle loan gauge display in which loan parameters are changed again in response to selection of a loan amount gauge according to one exemplary embodiment of the invention.

FIG. 7 is an exemplary vehicle loan display with selectable block shaped gauges according to one exemplary embodiment of the invention.

FIG. 8 is a logic flow diagram illustrating an exemplary method for calculating and displaying a vehicle loan according to one exemplary embodiment of the invention.

FIG. 9. is a logic flow diagram illustrating an exemplary sub-method or routine for determining values from a selected gauge according to one exemplary embodiment of the invention.

FIG. 10 is illustrating an exemplary sub-method or routine for determining gauge positions from a calculated value according to one exemplary embodiment of the invention.

### DETAILED DESCRIPTION OF EXEMPLARY EMBODIMENTS

A computer implemented method and system for displaying and calculating a vehicle loan can include various input fields for adjusting parameters associated with the vehicle loan as well as one or more selectable gauges that can also be used to adjust parameters of the vehicle loan. The gauges can comprise analog displays that include an indicator, such as a needle or graphical blocks, that can be selected and repositioned. The gauges can also have a design and feel that resemble gauges of a vehicle, like an automobile. The gauges can also display relative values that simulate relative values found in a vehicle, like an automobile.

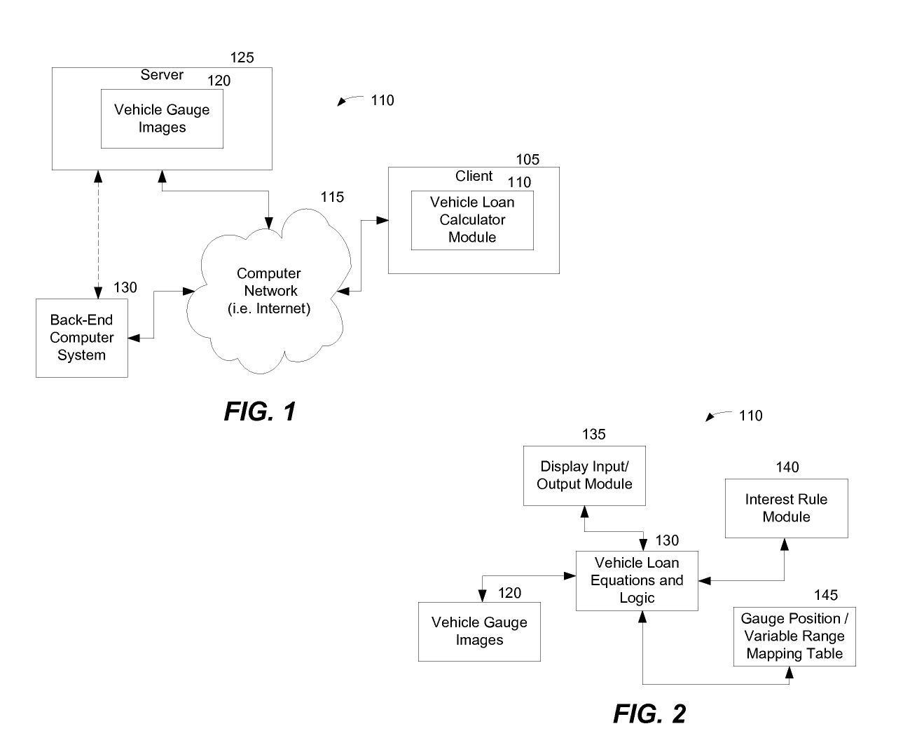

Referring now to the drawings, in which like reference numerals designate like elements, FIG. 1 is a functional block diagram of an exemplary computer architecture 100 according to one exemplary embodiment of the invention. The computer architecture 100 can comprise a three-tier architecture that includes a client computer 105, a computer server 125, and a back-end computer system 130. The client computer 105 can comprise a desktop, laptop, or handheld computer. The client computer 105 can execute and run a vehicle loan calculator module 110.

This vehicle loan calculator module 110 can comprise a program that is executed by an internet browser such as Microsoft's Internet Explorer and Netscape's Navigator. The vehicle loan calculator module 110, according to one exemplary embodiment, can programmed in the computer language of Java Script. However, other computer languages can be used without departing from the scope and spirit of the invention. For example, the vehicle loan calculator module 110 can be programmed in Java. Other computer languages include, but are not limited to, C, C++, Visual Basic, and other like computer languages. Further, the vehicle loan calculator module 110 may also comprise a stand alone program that is not executed by an Internet browser according to exemplary embodiments not illustrated or described but that are within the scope of the invention.

The vehicle loan calculator module 110 running on the client computer 105 can access on or more gauge images 120 that are stored on the server computer 125. The gauge images can comprise exemplary screens that illustrate different positions of a gauge pointer. Further details of the gauge images 120 stored on the computer server 125 will be described below.

The client computer 105 can be coupled to a computer network 115 such as the Internet. Meanwhile, the server computer 125 that has the one or more gauge images 120 can also be coupled to the computer network 115. The client computer 105 and server computer 125 can communicate with one another over the computer network 115. The server computer 125 can also communicate with a back-end computer system 130.

The server computer 125 can communicate with the back-end computer system 130 over the computer network 115 or it may communicate with the back-end computer system 130 through a direct connection. The back-end computer system 130 can track and store a business account that may be associated with a computer user of the client computer 130. The back-end computer system 130 can comprise databases and database software that maintains the business account of the computer user. The business account may comprise information that supports one or more vehicle loan offers and vehicle loans.

Referring now to FIG. 2, this figure is a functional block diagram illustrating some core components of a vehicle loan computer module 110 according to one exemplary embodiment of the invention. The vehicle loan computer module 110 can comprise vehicle loan equations and logic sub-module 130. The vehicle loan equations and logic module 130 can comprise computer code that contains one or more loan equations that can be used to calculate different parameters for a computer user. For example, this module 130 can comprise computer code that can calculate a monthly loan payment amount for a computer user if the user provides data for other loan parameters, such as term, loan amount, and interest rate.

The module 130 can also include computer code that can calculate a loan amount for a computer user if the computer user provides data for other loan parameters, such as the term, monthly payment, and interest rate. The vehicle loan equations and logic module 130 can communicate with a display input/output module 135, an interest rule module 140, and a gauge position/variable range mapping table 145. The vehicle loan equations and logic module 130 can also access the gauge images 120 that may reside on the computer server 125.

The display input/output module 135 can comprise computer programming functions and computer code for displaying information on a computer display. The display input/output module 135 can also track any input that is generated by a user through key-strokes or cursor selections (mouse movement).

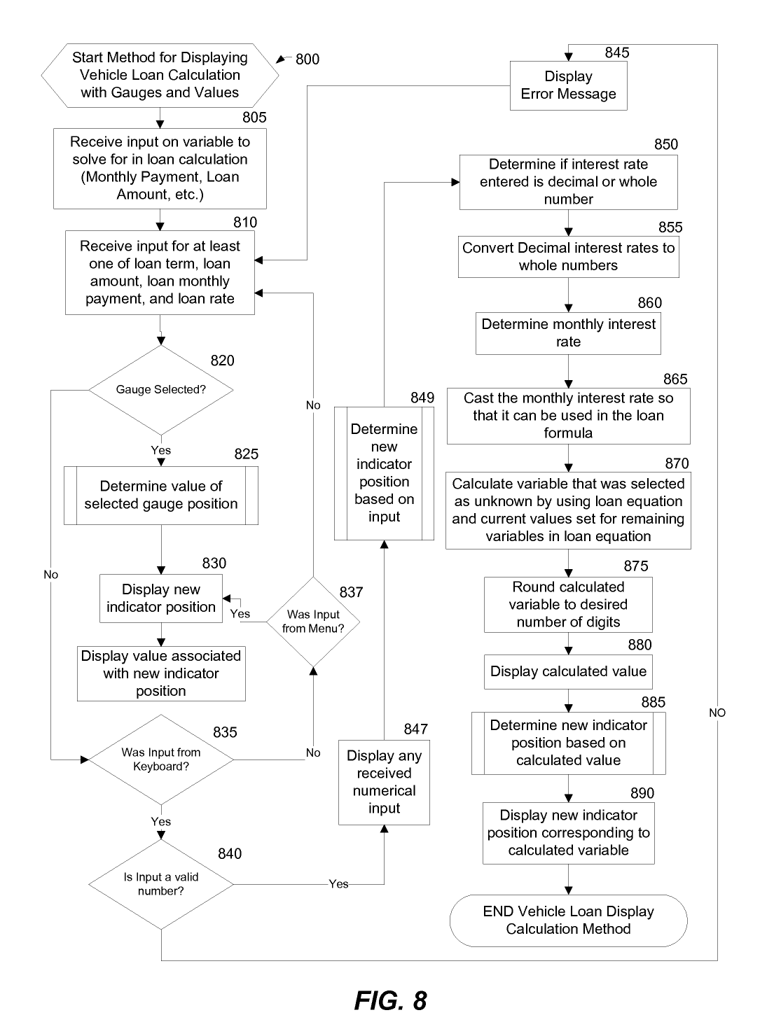

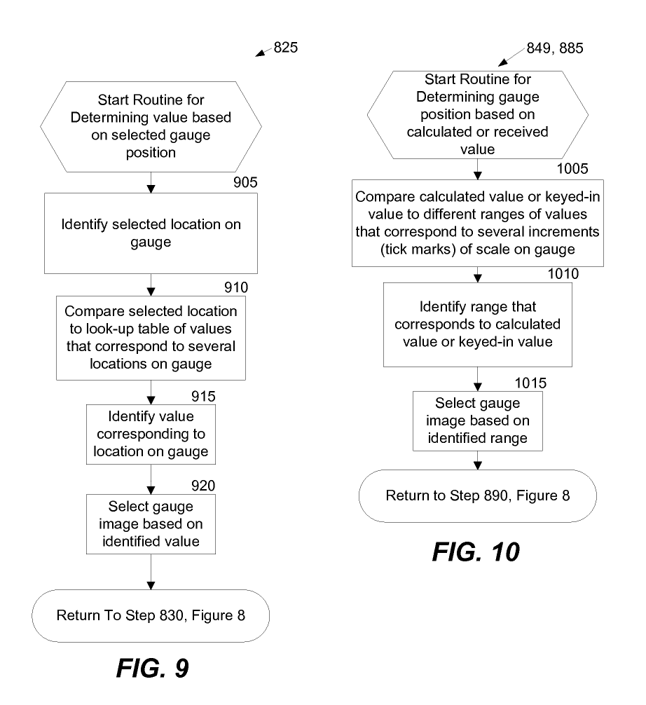

The interest rule module 140 can comprise computer code that includes calculations and/or procedures for managing vehicle interest rates selected or keyed-in by a computer user. Further details of the interest rule module 140 will be described below with respect to the process flow chart illustrated in FIG. 8.

The gauge position/variable range mapping table 145 can comprise computer code that supports mapping of vehicle gauge images 120 with corresponding values or ranges of values. For example, if a computer user selects a gauge on a computer display so that the computer user can change a loan equation parameter such as the interest rate, the gauge position/variable range mapping table 145 can help identify a gauge image 120 with a needle position that corresponds with a new value that was selected by a user. Similarly, if a new loan amount is calculated, the gauge position/variable range mapping table 145 can be accessed by the vehicle loan equations and logic module 130 in order to identify a gauge image 120 with a needle position that corresponds with a new value that was calculated by the vehicle loan equations and logic module 130.

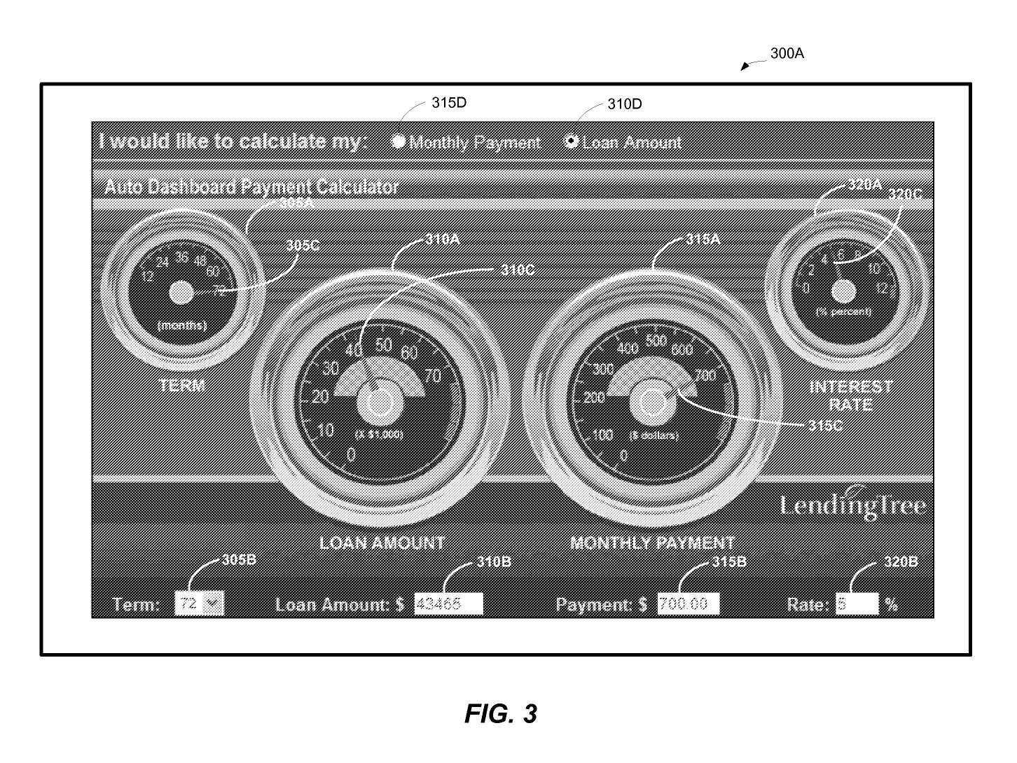

Referring now to FIG. 3, this figure is an exemplary vehicle loan gauge display 300A with values according to one exemplary embodiment of the invention. The vehicle loan gauge display 300A can comprise various different gauges and input fields that relate to vehicle loan parameters. The various gauges can include, but are not limited to, a loan term gauge 305A, a loan amount gauge 310A, a monthly loan payment gauge 315A, and a loan interest rate gauge 320A.

Input fields and/or menus can also be displayed and used. Exemplary input fields and/or menus can include, but are not limited to, a loan term drop down menu 305B, a loan amount input field 310B, a loan payment input field 315B, and a loan interest rate input field 320B. One of ordinary skill in the art recognizes that drop down menus can easily be substituted for input fields and vice-versa. Drop down menus offer the advantage of controlling input such as for maximum and minimum points of ranges as well as appropriate increments between the minimum and maximum points of a range.

According to this exemplary embodiment illustrated in FIG. 3, each gauge can comprise an analog display that includes a moveable indicator, such as a needle, that can be selected and repositioned. The gauges can also have a design and feel that resemble gauges of a vehicle, such as an automobile. However, the invention is not limited to automobile type gauges. Other vehicle gauges include, but are not limited to, gauges for motorcycles, boats and other aquatic vehicles, aircraft, and other like vehicles.

Each gauge has a respective moveable indicator, such as needles 305C, 310C, 315C, and 320C. With these moveable indicators, the gauges can display relative values and a range that simulates relative values and ranges found in a vehicle, like an automobile. For example, a first gauge 310A displaying a loan amount can be scaled in such a manner that it resembles a gauge for tracking automobile speed, like a speedometer. In the exemplary embodiment illustrated in the Figures, the gauges usually do not indicate exact values such as down to a single digit of a multiple-digit value. Each gauge usually provides a needle that moves across a range of values at certain increments that may or may not be at single digit increments. Meanwhile, the text fields below the gauges can display exact values such as down to a single digit of a multiple-digit value.

In the exemplary embodiment illustrated in FIG. 3, the loan amount gauge 310A displays a range of zero to seventy in which each increment is multiplied by approximately one-thousand dollars. This means that the loan amount gauge 310A can display values that represent between one and seventy thousand dollars. Any value above seventy thousand dollars is displayed in the red zone above the range. One of ordinary skill in the art recognizes that other end points of the range as well as increments and scale of the loan amount gauge 310A can be chosen without departing from the invention.

As another example, a second gauge 315A displaying monthly payment can be scaled in such a manner that it resembles a gauge for tracking revolutions per minute (RPM) of an engine of automobile, such as a tachometer. In the exemplary embodiment illustrated in FIG. 3, the monthly payment gauge 315A displays a range of zero to 700 in which each increment is multiplied by one dollar. This means that the monthly payment gauge 315A can display values that represent between one and seven hundred dollars. Any value above seven hundred dollars is displayed in the red zone above the range. One of ordinary skill in the art recognizes that other end points of the range as well as increments and scale of the monthly payment gauge 315A can be chosen without departing from the invention.

Similarly, a third gauge 305A displaying a loan term in months can be scaled in such a manner that it resembles a gauge for tracking vehicle temperature, battery voltage, or engine oil pressure. The loan term gauge 305A displays a range of twelve to seventy-two in which each increment is multiplied by one month. This means that the loan term gauge 305A can display values that represent between twelve and seventy-two months. Any value above seventy-two months is displayed in the red zone above the range. One of ordinary skill in the art recognizes that other end points of the range as well as increments and scale of the loan term gauge 305A can be chosen without departing from the invention.

A fourth gauge 320A displaying a loan interest rate can be scaled so that it resembles a gauge for tracking vehicle temperature, battery voltage, or engine oil pressure. The loan interest gauge 320A displays a range of zero to twelve in which each increment is divided by 100 to represent a percentage. This means that the loan interest gauge 320A can display values that represent between zero and twelve percent. Any value above twelve percent is displayed in the red zone above the range. One of ordinary skill in the art recognizes that other end points of the range as well as increments and scale of the loan percentage gauge 320A can be chosen without departing from the invention.

According to the exemplary embodiment illustrated in FIG. 3, a computer user can select one of two parameters to calculate with the vehicle loan calculator. A computer user can select either to calculate a monthly loan payment 315D or a total loan amount 310D. When a computer user selects one of these two options, the vehicle loan calculator module 110 will freeze or lock the opposing options. One of ordinary skill in the art recognizes that additional options could be provided. For example, the vehicle loan calculator could provide options for solving for other vehicle loan parameters such as loan term 305 or interest rate 320 without departing from the scope and spirit of the invention.

In the two option embodiment illustrated in FIG. 3, if the computer user selects to solve or calculate a total loan amount 310D, the vehicle loan calculator module 110 will freeze or lock the monthly payment 315 if the user decides to modify the values for the loan term 305 or interest rate 320. In this way, the computer user can select and “modify” these other vehicle loan parameters, such as the loan term 305 and interest rate 320, to determine different values of the loan amount 310 while the monthly loan payment 315 is held constant. When modifying the loan term 305 and interest rate 320, the computer user will readily see and learn the relationships between these loan parameters and their impact on the loan amount 310.

Similarly, if the computer user selects to solve or calculate a monthly payment 315D, the vehicle loan calculator module 110 will freeze or lock the loan amount 315 if the user decides to modify the values for the loan term 305 or interest rate 320. In this way, the computer user can select and “modify” these other vehicle loan parameters, such as the loan term 305 and interest rate 320, to determine different values of the monthly payment 315 while the loan amount 310 is held constant. When modifying the loan term 305 and interest rate 320, the computer user will readily see and learn the relationships between these loan parameters and their impact on the monthly payment 315.

In the two option exemplary embodiment illustrated in FIG. 3, if a computer user selects one of the options 315D, 310D to solve with the vehicle loan calculator and then selects either a gauge or input field that corresponds to the selected option, then the vehicle loan calculator module 110 will automatically switch the option that was selected. For example, if a computer user selects the monthly payment option 315D and then the computer user selects the gauge 315A that corresponds to the monthly payment option 315D, the vehicle loan calculator module 110 will switch from the monthly payment option 315D to the loan amount option 310D. Similarly, if a computer user selects the loan amount option 310D and then the computer user selects the gauge 310A that corresponds to the total loan amount option 310D, the vehicle loan calculator module 110 will switch from the total loan amount option 310D to the monthly payment option 315D. One of ordinary skill in the art recognizes that this “switch” is made because the vehicle loan calculator cannot solve for variables that are manipulated by the computer user.

A computer user can modify any of the loan parameters by simply selecting regions on a respective gauge or by entering data into respective input fields. A computer user can also modify loan parameters by also selecting values from drop down menus, such as the drop down menu 305B for the loan term illustrated in FIG. 3.

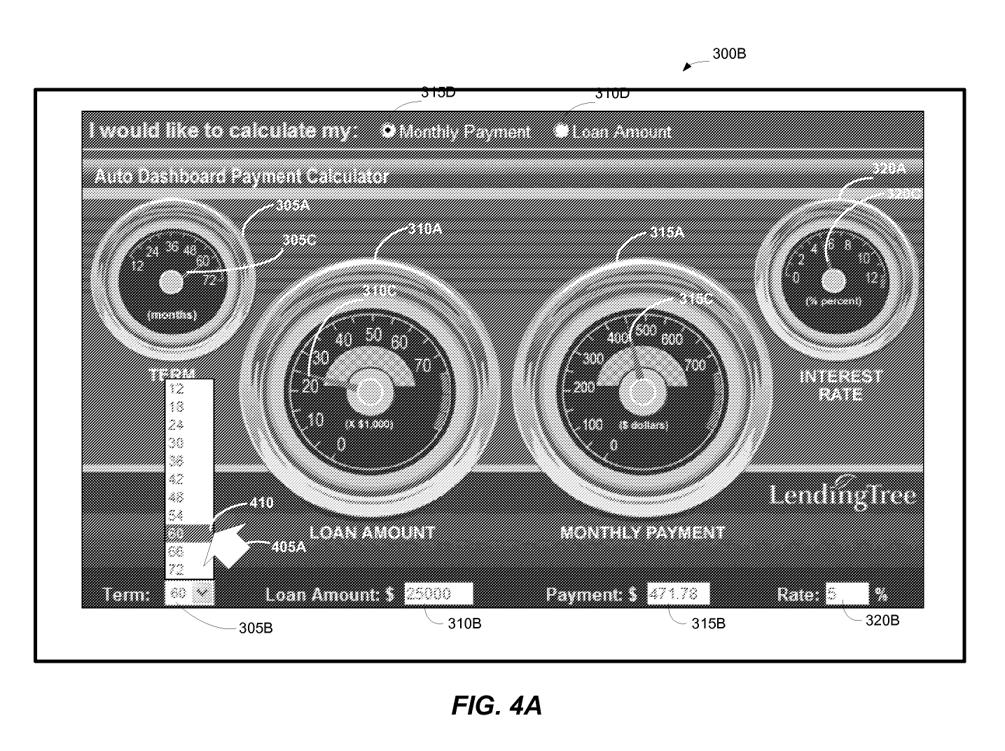

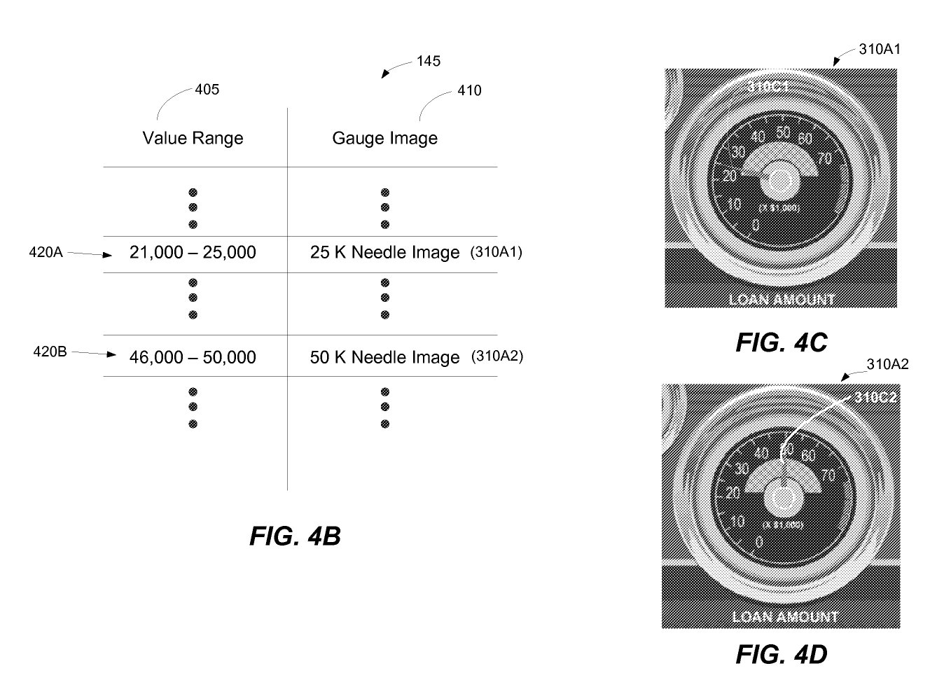

Referring now to FIG. 4A, this Figure is an exemplary vehicle loan gauge display 300B in which a user selected the monthly payment option 315D, keyed-in a value of twenty-five thousand dollars in the loan amount input field 310B, and maintained a value of five percent in the interest rate input field 320B (relative to the display 300A of FIG. 3). The computer user also selected a loan term 305 of sixty months from a drop down menu 305B with a display pointer 405A. When the loan term 410 of sixty months 410 was selected, the vehicle loan calculator module 110 determined the monthly loan payment 315 of $471.78 and listed this value in the loan payment input field 315B. The vehicle loan calculator module 110 then determined the appropriate value of forty-five hundred to display with the loan payment gauge 315A.

Referring now to FIG. 4B, this figure is an exemplary gauge position/variable range mapping table 145 according to one exemplary embodiment of the invention. The mapping table 145 can comprise two columns: a first column comprising a value range column 405 and a second column comprising a gauge image file reference column 410. This table can be accessed by the vehicle loan calculator module 110 after the module 110 performs a calculation or after a user selects an increment on the loan amount gauge 310A. This exemplary mapping table 145 illustrated in FIG. 4B is designed to support the operation of the loan amount gauge 310A. However, the mapping table 145 may also comprise additional value ranges 405 and corresponding needle images references 410 that are designed to support other gauges, such as the loan term gauge 305A, monthly payment gauge 315A, and interest rate gauge 320A.

A first row 420A of the mapping table 145 supports a loan amount value range 405 of between 21,000 and 25,000 dollars. The gauge image that corresponds with this loan amount value range is the 25 K needle image 310A1. Referring briefly to FIG. 4C, this figure illustrates the 25 K needle image 310A1. As its name implies, the 25 K needle image 310A1 has an indicator comprising a needle 310C1 that is pointing to the 25,000 increment on the loan amount gauge 310A1. Therefore, if the vehicle loan calculator module 110 determines a loan amount value 310 that falls between 21,000 and 25,000 dollars or if a computer user selects region on the display 300 that falls within the 21,000 and 25,000 increment marks or if the computer user enters a dollar value into the loan amount input field 310B that falls within the 21,000 and 25,000 dollar range, the calculator module 110 will use the first row 420A of the mapping table 145 to select the 25 K needle image 310A1.

Referring briefly back to FIG. 4B, if the vehicle loan calculator module 110 determines a loan amount value 310 that falls between 46,000 and 50,000 dollars or if a computer user selects region on the display 300 that falls within the 46,000 and 50,000 increment marks or if the computer user enters a dollar value into the loan amount input field 310B that falls within the 46,000 and 50,000 dollar range, the calculator module 110 will use the second row 420B of the mapping table 145 to select the 50 K needle image 310A2.

Referring now to FIG. 4D, this figure illustrates the 50 K needle image 310A2. As its name implies, the 50 K needle image 310A2 has an indicator comprising a needle 310C2 that is pointing to the 50,000 increment on the loan amount gauge 310A2.

One of ordinary skill in the art recognizes that the invention is not limited to the gauge position/variable range mapping table 145 and the gauge images 120. The invention could be implemented using another computer language and/or platform, such as JAVA or FLASH, so that a more dynamic computer display 300 could be rendered. In such a dynamic display (not illustrated), the mapping table 145 (not illustrated) may track the exact position of the screen pointer 405 using X and Y coordinates instead of a region or portion of the display. With the X and Y values of the screen pointer 405 stored in the table 145, the calculator module 110 could then determine the new position of the gauge indicator such as a needle. The calculator module 110 could then redraw the needle in its new position. This dynamic redrawing of the needle in a new position is different relative to the illustrated embodiment in which a new image 120 with the correct needle placement is simply selected by the calculator module 110 and displayed.

In an exemplary FLASH embodiment (not illustrated), the drop down loan term menu 305B could remain as described in the JAVA script embodiment. However, the loan term gauge 305A could be displayed utilizing a dynamic movieClip that could correspond with a user's input and any calculations made by the vehicle loan calculator module 110. Using a function, any input received from the drop down menu 305B could move the needle 305C of the loan term gauge 305A to the selected value.

In this exemplary FLASH embodiment (not illustrated), the loan amount input field 310B could function as an “input” text field. Action script code could be used to create a math function to determine any results for a loan calculation. Any value inserted by a user in the loan amount input field could be plugged into the math function. In this FLASH embodiment, the inserted value could be rounded to a number that is closest to an “even” number. For example, a loan amount of $21,344 could be rounded to $22,000. This rounded value could then be used to move the needle 310C to the appropriate value on the loan amount gauge 310A.

As another example in an exemplary FLASH embodiment (not illustrated), the monthly payment input field 315B could function as a “dynamic” text field. The results of any vehicle loan calculation could be displayed dynamically as the user enters any values. This dynamic field will likely require an onEnterFrame clip function so that it can be constantly updated. A variable could be created that is constantly updated from the dynamic field of the monthly payment input field 315B. This variable could then be plugged into a math function to round any input to a nearest quarter numbers. For example, a monthly payment input of $235 could be rounded to $225. This rounded value could then be used to move the needle 315C to the appropriate value on the monthly loan payment gauge 315A.

For a FLASH embodiment of the loan interest rate input field 320B (not illustrated), this field 320B could function as either a drop down menu like the drop down loan term menu 305B or an input text. In a FLASH implementation, a drop down menu for the loan interest rate input field 320B would likely be preferred. The loan interest rate gauge 320A could be implemented as a dynamic movieClip that can correspond with a user's input. Using a function, any value entered into the loan interest rate input field 320B could be used to move the needle 320C of the loan interest rate input gauge 320A to the appropriate value. This entered value could then be plugged into the loan formula used by the vehicle loan calculator module 110. In this exemplary FLASH embodiment, all four gauges 305A, 310A, 315A, and 320A could be part of a movieClip that could be constantly updated with an onEnterFrame function.

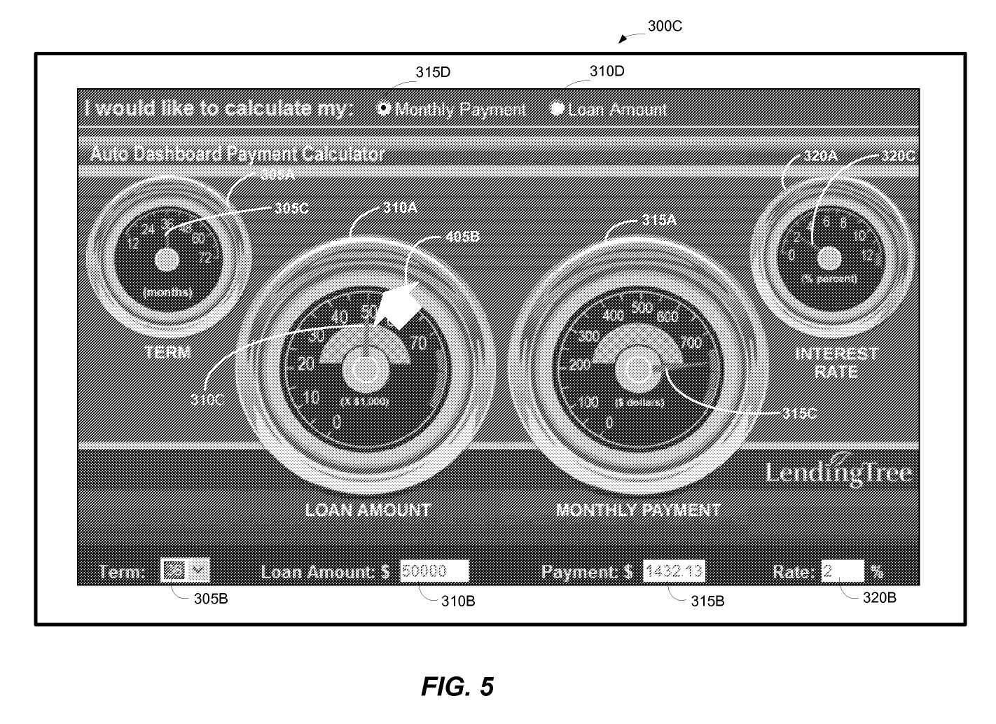

Referring now to FIG. 5, this figure is an exemplary vehicle loan gauge display 300C in which loan parameters are changed in response to selection of a loan amount gauge 310A according to one exemplary embodiment of the invention. Relative to FIG. 4A, the loan term 305 was selected and changed to thirty six months. The graphical region near the 50,000 increment of the scale on the loan amount gauge 310A was selected with the screen pointer 405B and the new gauge image comprising the loan amount gauge 310A2 with an indicator 310C pointing to the 50,000 increment was displayed. A new loan interest rate of two percent was entered into the interest rate input field 320B and the corresponding interest rate gauge 320B was displayed. The calculator module 110 determined the monthly loan payment amount of $1432.13 and displayed this value in the monthly loan payment input field 315B. The calculator module 110 also displayed an image of the monthly loan payment gauge 315 having an indicator pointing to the red zone increments on the scale of the monthly loan payment gauge.

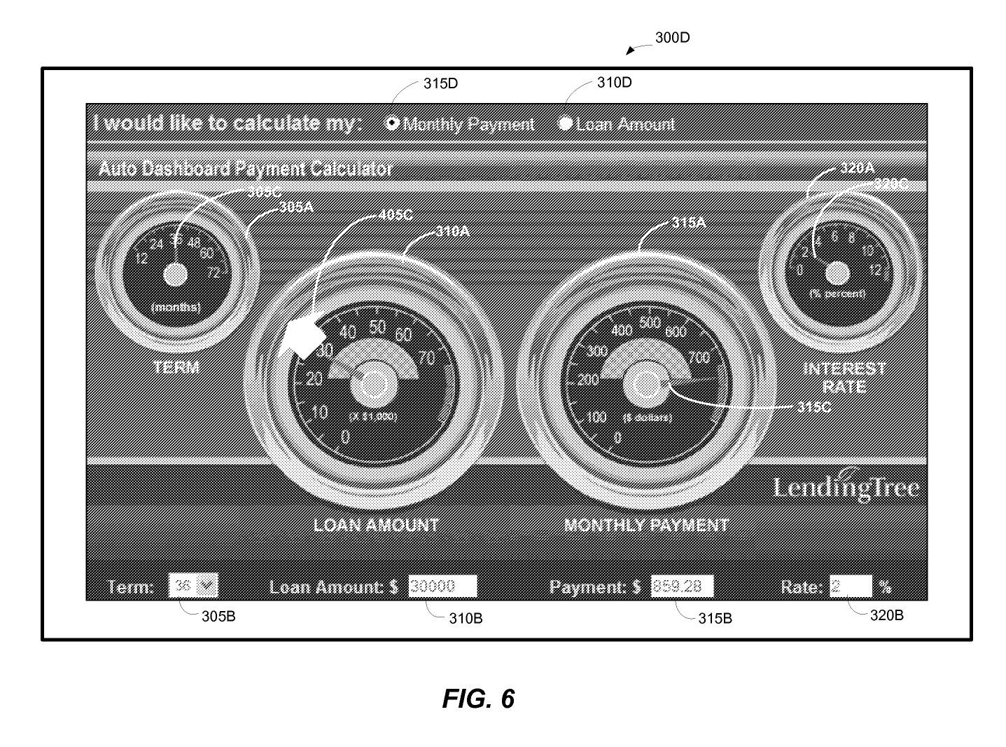

Referring now to FIG. 6, this figure is an exemplary vehicle loan gauge display 300D in which loan parameters are changed again in response to selection of a loan amount gauge 310A according to one exemplary embodiment of the invention. Since FIG. 5 and FIG. 6 are very similar, only the differences between the figures will be described. The graphical region near the 30,000 increment of the scale on the loan amount gauge 310A was selected with the screen pointer 405C and the new gauge image comprising the loan amount gauge 310A1 with an indicator 310C pointing to the 50,000 increment was displayed. The calculator module 110 determined the monthly loan payment amount of $859.28 and displayed this value in the monthly loan payment input field 315B. The calculator module 110 also displayed an image of the monthly loan payment gauge 315 having an indicator pointing to the red zone increments on the scale of the monthly loan payment gauge because the calculated value was above the 700 end point of the monthly loan payment gauge scale.

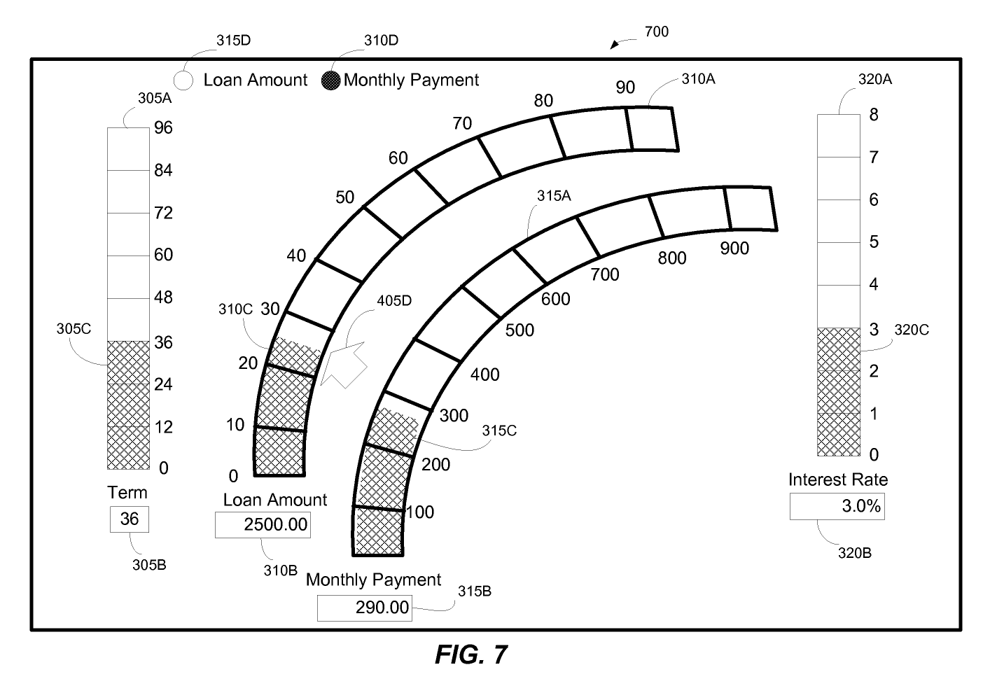

Referring now to FIG. 7, this figure illustrates an exemplary vehicle loan display 700 with selectable block shaped indicators 305C, 310C, 315C, and 320C according to one exemplary embodiment of the invention. According to this exemplary embodiment, the indicators 305C, 310C, 315C, and 320C used to point to the increments on each scale of a gauge and that can be selected can comprise blocks that are used to populate bar-chart like gauges 305A, 310A, 315A, and 320C respectively. In view of the exemplary embodiment illustrated in FIG. 7, one of ordinary skill in the art recognizes that other types of indicators and gauges with different geometries are not beyond the scope of the invention.

Referring now to FIG. 8, this figure is a logic flow diagram illustrating an exemplary method 800 for calculating and displaying a vehicle loan according to one exemplary embodiment of the invention. One of ordinary skill in the art will appreciate that process and functions described in connection with FIG. 8 can be performed by a general processor. Alternatively, the process and functions described with respect to FIG. 8 can be performed by firmware code executed on a microcontroller, microprocessor, or DSP processor state machines implemented in application specific or programmable logic; or numerous other forms without departing from the invention.

In other words, the invention may be provided as a computer program which may include a machine-readable medium having stored thereon instructions which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions.

Certain steps in the processes or process flow described in all of the logic flow diagrams referred to below must naturally precede others for the invention to function as described. However, the invention is not limited to the order of the steps described if such order or sequence does not alter the functionality of the present invention. That is, it is recognized that some steps may be performed before, after, or in parallel other steps without departing from the scope and spirit of the present invention.

Further, one of ordinary skill in the art would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented processes will be explained in more detail in the following description in conjunction with the Figures illustrating process flows.

Referring again to FIG. 8, step 805 is the first step of the method or process 800 for calculating and displaying a vehicle loan. In step 805, the vehicle loan calculator module 110 can receive input on the variable of interest: either the monthly payment 315D or loan amount 310D as illustrated by the radio selection buttons in FIG. 3. Next in step 810, the vehicle loan calculator module 110 can receive input for at least one of the loan term 305, loan amount 310, loan monthly payment 315, or loan interest rate 320. This input can be received from the input boxes 310B, 315B, 320B or drop down menus such as drop down menu 305B, or through any selection of increments or regions on the vehicle gauges 305A, 310A, 315A, and 320A.

Next, in decision step 820, the vehicle loan calculator module 110 determines if any vehicle gauge was selected by a computer user. If the inquiry to decision step 820 is negative, then the “No” branch is followed to decision step 835. If the inquiry to decision step is positive, then the “Yes” branch is followed to routine 825 in which a value is determined by the vehicle loan calculator module that corresponds with the selected gauge position. Further details of routine 825 will be described below with respect to FIG. 9.

Next, in step 830, after the new indicator position is determined, the new indicator or needle position that is part of the gauge image file 120 selected by the vehicle loan calculator module 110 can be displayed. In step 832, the numerical value associated with the new indicator position can be displayed in the input box that corresponds to the gauge. The process then proceeds to step 870.

In decision step 835, the vehicle loan calculator module 110 determines if input was received from a keyboard. If the inquiry to decision step 835 is negative, then the “No” branch is followed to decision step 837. In decision step 837, the vehicle loan calculator module 110 determines if input was received from a drop down menu. If the inquiry to decision step 837 is positive, then the “Yes” branch is followed to step 830. If the inquiry to decision step 837 is negative, then the “No” branch is followed back to step 810.

If the inquiry to decision step 835 is positive, then the “Yes” branch is followed to decision step 840. In decision step 840, the vehicle loan calculator module 100 determines if the keyboard input is a valid number. For example, the vehicle loan calculator module 110 can determine if the computer user enters a negative numerical value or a numerical value that is entered into the loan amount input field 310B or payment input field 315B. These instances are considered to be invalid.

Therefore, if the inquiry to decision step 840 is negative, the “No” branch is followed to step 845 in which an error message is displayed. The process then returns to step 810. However, if the inquiry to decision step 840 is positive, the “Yes” branch is followed to step 847. In step 847, any valid numerical values received in input boxes 310B, 315B, 320B are displayed. Next in routine 849, the vehicle loan calculator module 110 can determine the new indicator position for the gauge that corresponds to the received numerical values. Further details of routine 849 will be discussed below with respect to FIG. 10.

Next, in step 850, the vehicle loan calculator module 110 if any interest rate entered into the interest rate input field 320B is a decimal value or a whole number. In step 855, the vehicle loan calculator module converts any decimal interest rates to whole numbers. Next, in step 860, the vehicle loan calculator module 860 determines the monthly interest rate from the whole numbers.

In step 865, the month interest rate is casted by the vehicle loan calculator module 110 so that it can be used in the vehicle loan formula. In step 870, the variable selected in step 805 can be determined by the loan calculator module 110 using a vehicle loan equation and current values set for the remaining variables in the loan equation. According to one exemplary embodiment, the following vehicle loan equation can be used:

$$P = \frac{iA}{1 - {( 1 + i )}^{- N}}$$

A=Loan amount
i=interest rate per period (not per year). For instance, if the loan payments are made monthly and the interest rate is 9%, then i=9%/12=0.75%=0.0075.
N=total number of payments for the entire loan or investment. In this case, N is represented in “months”
P=the amount of each equal payment

In step 875, the calculated variable of the vehicle loan equation is rounded to a desired number of digits. For either the total loan amount 310 or loan payment amount 315, this value is usually rounded to two digits to reflect cents in U.S. dollars. However, the degree of rounding can be adjusted based on other preferences or based on the type of currency being considered or any combination thereof.

In step 880, the value calculated by the vehicle loan calculator module 110 can be displayed in the appropriate input field such as the total loan amount input field 310B or monthly payment input field 315B. Next in routine 885, the vehicle loan calculator module 110 can determine the new indicator position for the gauge that corresponds to the value that was calculated. Further details of routine 885 will be discussed below with respect to FIG. 10.

In step 890, the new indicator position such as a new position for a needle in a selected gauge image file 120 is displayed. The process then ends.

Referring now to FIG. 9, this figure is a logic flow diagram illustrating an exemplary sub-method or routine 825 for determining values from a selected gauge according to one exemplary embodiment of the invention. Step 905 is the first step of this sub-method 825. In step 905, the vehicle loan calculator module 110 identifies a location on a gauge that is selected by a computer user. Often, this location will correspond to an increment on a scale of a vehicle gauge that is not where the indicator, such as a needle 305C as illustrated in FIG. 3 or a selectable block region 305c as illustrated in FIG. 7, is located or positioned.

For example, in FIG. 3, a computer user may select the increment of fifty of the scale of the loan term gauge 305A. Meanwhile, the current position of the needle indicator 305C is on the increment of seventy-two. Similarly, in FIG. 7, a computer user may select the increment of sixty of the loan term gauge 305A. Meanwhile, the current position of the block indicator 305C is on the increment of thirty-six.

Next, in step 910, the vehicle loan calculator module 110 can compare the selected location to a look-up table, such as table 145 illustrated in FIG. 4B. The vehicle loan calculator module can compare the selected location on the gauge to the value range column 405. Next, in step 915, the vehicle loan calculator module 110 can identify a single value corresponding to the value range listed in the value range column 405. For example, if a computer user selected a point on the loan amount gauge 310A that fell within the value range of between 21,000 and 25,000, the vehicle loan calculator module 110 would select the single value of 25,000 to pass to the loan equation. In step 920, the vehicle loan calculator module 110 would also select the 25 K Needle Image 310A1 for displaying on the computer display 300. The process would then return to step 830 of FIG. 8.

Referring now to FIG. 10, this figure is a logic flow diagram illustrating an exemplary sub-method or routine 849, 885 for determining gauge positions from either a calculated value or keyed-in value according to one exemplary embodiment of the invention. Step 1005 is the first step of this sub-method 885. In step 1005, the vehicle loan calculator module 110 can compare a calculated value or received keyed-in value, such as a loan amount 310 or a monthly payment 315, to a look-up table and corresponding ranges of values, such as those in table 145 illustrated in FIG. 4B.

Next, in step 1010, the vehicle loan calculator module 110 can identify a value range listed in the value range column 405 that corresponds to the calculated value or keyed-in value. After identifying the appropriate range for the calculated or keyed-in value in step 1010, in step 1015, the vehicle loan calculator module 110 can select a corresponding image file listed in the table. For example, if a calculated or keyed-in value falls within the value range of between 21,000 and 25,000, the vehicle loan calculator module 110 would look at the second column containing the gauge image file references and then select the 25 K Needle Image 310A1 for displaying on the computer display 300. The process would then return to step 890 of FIG. 8.

A computer implemented method and system has been described for displaying and calculating vehicle loans without consuming significant computer server resources. The invention provides a user interface to a computer vehicle loan calculator that engages the interest of a user and that may readily display relationships between vehicle loan parameters in a graphical manner as well as providing exact parameters that can be useful to the computer user. A computer implemented method and system for displaying and calculating a vehicle loan can include various input fields for adjusting parameters associated with the vehicle loan as well as one or more selectable gauges that can also be used to adjust parameters of the vehicle loan. The gauges can comprise analog displays that include an indicator, such as a needle or graphical blocks, that can be selected and repositioned. The gauges can also have a design and feel that resemble gauges of a vehicle, like an automobile. The gauges can also display relative values that simulate relative values found in a vehicle, like an automobile.

What is claimed is:

1. A computer-implemented method for displaying and calculating a vehicle loan, comprising:
displaying a gauge on a display device comprising a range of values that correspond to the vehicle loan;
receiving input comprising one of a selection of a region on a gauge and insertion of a number in a field;
calculating a parameter of the vehicle loan based on the input;
redisplaying the gauge with an indicator pointing to a value corresponding to the input; and
displaying a number in the field corresponding to one of the input and calculated parameter.

2. The method of claim 1, wherein redisplaying the vehicle gauge with a value comprises looking up a value in a table that corresponds with the calculated parameter.

3. The method of claim 1, further comprising scaling the range of values that correspond with gauge values of an automobile.

4. The method of claim 1, wherein displaying a vehicle gauge on a display device further comprises displaying a gauge comprising an analog indicator.

5. The method of claim 1, wherein the analog indicator comprises a needle.

6. The method of claim 1, wherein the analog indicator comprises a graphical block.

7. The method of claim 1, wherein displaying a gauge on a display device comprises displaying a gauge comprising a range of values corresponding to a vehicle loan term.

8. The method of claim 1, wherein displaying a gauge on a display device comprises displaying a gauge comprising a range of values corresponding to a vehicle loan amount.

9. The method of claim 1, wherein displaying a gauge on a display device comprises displaying a gauge comprising a range of values corresponding to a vehicle loan annual percentage rate.

10. The method of claim 1, wherein displaying a gauge on a display device comprises displaying a gauge comprising a range of values corresponding to a vehicle loan interest rate.

11. A computer-implemented method for displaying and calculating a vehicle loan, comprising:
displaying a gauge on a display device comprising a range of values that correspond to the vehicle loan;
receiving input comprising one of a selection of a region on a gauge and insertion of a number in a field;
calculating a parameter of the vehicle loan based on the input; and
redisplaying the gauge with an indicator pointing to an increment of a scale on the gauge.

12. The method of claim 11, wherein the gauge comprises a scale corresponding to an interest rate of the vehicle loan.

13. The method of claim 11, wherein the gauge comprises a scale corresponding to a loan term for the vehicle loan.

14. The method of claim 11, wherein the gauge comprises a scale corresponding to a loan amount for the vehicle loan.

15. The method of claim 11, wherein the gauge comprises a scale corresponding to a monthly payment for the vehicle loan.

16. A system for displaying and calculating a vehicle loan, comprising:
a processing unit;
a memory storage device;
a display device coupled to the processing unit for displaying data; and
a program module, stored in said memory storage device for providing instructions to said processing unit;
said processing unit responsive to said instructions of said program module and operable for
displaying a gauge on the display device comprising a range of values that correspond to the vehicle loan;
calculating a parameter of the vehicle loan based on input;
redisplaying the gauge with an indicator pointing to an increment of a scale on the gauge.

17. The system of claim 16, wherein said processing unit is further operable for receiving input comprising one of a selection of a region on a gauge and insertion of a number in a field.

18. The system of claim 17, wherein said processing unit is further operable for displaying a number in the field corresponding to one of the input and calculated parameter.

19. The system of claim 16 wherein the gauge comprises a circular analog measuring device.

20. The system of claim 16, wherein the gauge comprises a bar chart that is adjustable.
